(19) United States
(12) Patent Application Publication
(10) Pub. No.: US 2016/0076514 A1
(43) Pub. Date: Mar. 17, 2016

(54) Turbine Blade

(71) Applicant: URBAN GREEN ENERGY, INC., New York, NY (US)

(72) Inventors: Patrick Tyson McKnight, Brooklyn, NY (US); Nicolas Blitterswyk, New York, NY (US)

(73) Assignee: Uraban Green Energy, INC., New York, NY (US)

(21) Appl. No.: 14/888,457

(22) PCT Filed: May 2, 2014
(86) PCT No.: PCT/US14/36468

§ 371 Date: Nov. 2, 2015

Related U.S. Application Data
(60) Provisional application No. 61/854,893, filed on May 3, 2013.

(51) Int. Cl. F03D 3/06; F03D 9/00; F03D 3/00

(52) U.S. Cl. CPC F03D 3/061; F03D 3/005; F03D 9/002

(57) ABSTRACT

An energy producing rotating assembly comprising blade(s) with an airfoil cross-section, wherein said airfoil cross section has an asymmetrical airfoil measurement.

### TECHNICAL FIELD

The present invention relates to the profile of a blade in the turbine power generation field.

### BACKGROUND ART

Conventional turbine blades are coupled to an energy producing rotating assembly, wherein the energy producing rotating assembly may be a turbine rotor, as moving fluid (fluid may include liquid(s) and/or gas(es)) interacts with the shape of the blade, torque is created which is used to spin an electrical generator. The unique shape of a blade will dictate how much torque is produced, and consequently how much energy can be extracted from the moving fluid. The orientation of the axis of rotation will also affect how the moving fluid will interact with the blade. A blade shape can be optimized for particular applications and fluid types including air and water.

The prevalence of turbine rotors, in particular, vertical axis wind turbines (VAWTs) has been hindered due to difficulties with start up without the help of external force and VAWTs being susceptible to dynamic stall. The ability of a VAWT to generate power is reduced whenever one or more rotor blades experience dynamic stall conditions. Therefore, it is desirable that dynamic stall conditions be avoided, or at least minimized. VAWT dynamic stall conditions experienced by rotor blades are dynamic in that the blades can transition in and out of regions where dynamic stall conditions are experienced as the Pastorates about its vertical rotational axis. The regions where rotor blades experience dynamic stall conditions as it rotates about the vertical rotational axis are referred to as “dynamic stall regions”.

US 201110236181 A1 discloses a vertical axis wind turbine comprises upper and lower rotor blades and upper and lower bearing assemblies. Horizontal members connect the upper rotor blades to the upper bearing assembly and the lower blades connect the upper rotor blades to the lower bearing assembly. The upper rotor blades can be arranged vertically or non-vertically. In non-vertical arrangements, the upper rotor blades can be twisted or swept back in a straight manner The turbine can be self-supporting with a need for a continuous vertical axis connecting the bearing assemblies.

Sweeping jet actuators are incorporated into the rotor blades to deliver oscillating air jets to surfaces of the rotor blades to delay occurrence of dynamic stall. Conduits in the blades can deliver pressurized flow of air to the actuators. The turbine can be supported by a structure that can exert only horizontal and/or lifting forces on the rotor blade assembly to reduce the load on the lower bearing. Mobley, Benedict (2013). Fundamental Understanding of the Physics of a Small-Scale Vertical Axis Wind Turbine with Dynamic Blade Pitching: An Experimental and Computational Approach. 54th AIAA/ASME/ASCE/AHS/ASC Structures, Structural Dynamics, and Materials Conference Apr. 8-11, 2013, Boston, Mass., 2013-1553. This paper discloses the systematic experimental and computational (CFD) studies performed to investigate the performance of a small-scale (VAWT) utilizing dynamic blade pitching. CFD analysis showed that the blade extracts all the power in the frontal half of the circular trajectory but loses power into the how in the rear half. One key reason for this occurrence is the large virtual camber and incidence induced by the how curvature ejects, which slightly enhances the power extraction in the frontal half, but increases the power loss in the rear half. It was found that the fixed-pitch turbine investigated also showed lower efficiency compared to the variable pitch turbines due to the massive blade stall in the rear half, caused by the large angle of attack and high reverse camber. The maximum achievable coefficient of power (CP) of the turbine increases with higher Reynolds numbers. However, the fundamental flow physics remains relatively same irrespective of the operating Reynolds number.

US 201110280708 A1 discloses a VAWT comprising a shaft rotatable about a longitudinal axis and a plurality of substantially rigid blades mechanically coupled to the shaft, each of the plurality of blades comprising an elongate body having an upper and a lower end, wherein the upper end and the lower end of each blade are rotationally off-set from each other about the longitudinal axis such that each blade has a helix like form, the section of the elongate body of each blade, taken perpendicularly to the longitudinal axis, being shaped as an airfoil having a leading edge and a trailing edge and a camber line defined between the leading edge and the trailing edge, characterized in that the airfoil is accurately shaped such that the camber line lies along a line of constant curvature having a finite radius of curvature.

US2009129928 A1 is directed to a turbine comprising a plurality of blades that rotate in a single direction when exposed to fluid flow, wherein the plurality of blades are joined to the central shaft by a plurality of radial spokes disposed substantially perpendicular to the central shaft such that the rotating plurality of blades causes the shaft to rotate. The plurality of blades has a uniform airfoil-shaped cross section, where the airfoil cross-section presents a non-zero angle of attack to the current. The plurality of blades wind in a spiral trajectory, rotating around the central shaft and having a variable radius along the length of the central shaft such that a distance measured from the plurality of blades to the center shaft is greater near the center of the turbine than at either end.

Andrzei Fiedler, Stephen, Tulles (2009). Blade Offset and Pitch Effects on a High Solidity Vertical Axis Wind Turbine. Wind Engineering Volume 33, No. 3, 2009 PP 237-246 discloses a high solidity, small scale, 2.5 m diameter by 3 ml high VAWT consisting of three NACA 0015 profile blades, each with a span of 3 m and a chord length of 0.4 m, was tested in an open-air wind tunnel facility to investigate the effects of preset toe-in and toe-out turbine blade pitch. The effect of blade mount-point offset was also investigated. The results from these tests are presented for a range of tip speed ratios, and compared with an extensive base data set obtained for a nominal wind speed of 10 m/s. Results show measured performance decreases of up to 47% for toe-in, and increases of up to 29% for toe-out blade pitch angles, relative to the zero preset pitch case. Also, blade mount-point offset tests indicate decreases in performance as the mount location is moved from mid-chord towards the leading edge, as a result of an inherent toe-in condition. Observations indicate that compensating may minimize these performance decreases for the blade mount offset with a toe-out preset pitch, The trends of the preset blade pitch tests agree with those found in literature for much lower solidity turbines.

An object of the present invention is to provide a turbine airfoil, which addresses at least some of the problems described above, to produce a more efficient and acceptable design and performance compared to known turbine airfoil shapes.

### DEFINITIONS

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

It must be noted that as used herein and in the appended claims, the singular forms “a,” “and” and “the” include plural references unless the context clearly dictates otherwise.

As defined herein, “NACA” is the National Advisory Committee for Aeronautics.

As defined herein, NACA XWYY is the 4-digit value assigned to an airfoil. In summary and as set forth in further detail in FIG. 13, the first digit describes maximum camber, the asymmetry between the top and the bottom surfaces of an airfoil as percentage of the chord. The second digit describes the distance of maximum camber from the airfoil leading edge in tens of percents of the chord. The last two digits describe the maximum thickness of the airfoil as percent of the chord. For example, the NACA 84112 airfoil has a maximum camber of 8% located 40% (0.4 chords) from the leading edge with a maximum thickness of 12% of the chord.

### SUMMARY OF THE INVENTION

Provided herein is an airfoil blade profile and blade configuration for an energy producing rotating assembly or turbine rotor capable of achieving high speeds needed for electrical generators.

The energy producing rotating assembly or turbine rotor comprises an airfoil blade. The blade(s) may be twisted up along a vertical line, vertical to the horizontal plane, to rotationally offset the top end and bottom end of the blade. The distances between the mentioned vertical line and the midpoint of the chord between leading edge and trailing edge of a series of airfoil cross sections of the mentioned blade may be the same or may vary (e.g., between 5 cm and 1000 cm).

The energy producing rotating assembly or turbine rotor may further comprise the turbine blade(s), and connecting arm(s). The connecting arm(s) may or may not comprise an airfoil profile, and rotor shaft. Both ends of the mentioned connecting arm(s) may be connected with the mentioned blade and the rotor shaft respectively. Secured with the connecting arm(s), the blade(s) may be twisted up along a vertical line, vertical to the horizontal plane, to rotationally offset the top end and bottom end of the blade and the distances between the mentioned vertical line and the midpoint of the chord between leading edge and trailing edge of a series of airfoil cross section of the mentioned blade are the same. The line intersectant with the mentioned vertical line and midpoint of the mentioned chord in the same plane may form a set angle with the mentioned chord, wherein, the first line and the second line may form a set angle, and the mentioned first line may be the one intersectant with the mentioned vertical line and the midpoint of the chord at the top most airfoil cross section(s) of the mentioned blade, while the second line may be the one intersectant with the mentioned vertical line and the midpoint of the chord at the bottom most airfoil cross section of the mentioned blade.

Preferably, the mentioned energy producing rotating assembly or turbine rotor may be equipped with one or more blades and the vertical projection of the mentioned one or more blades may form a closed circle. More preferably, the mentioned energy producing rotating assembly or turbine rotor may be equipped with three blades, and the vertical projection of the mentioned three blades may form a closed circle.

In a particular embodiment, the energy producing rotating assembly is a vertical axis wind turbine (VAWT). Preferably, the mentioned energy producing rotating assembly or turbine rotor may be equipped with one or more blades and the vertical projection of the mentioned one or more blades may form a non-closed circle. More preferably, the mentioned energy producing rotating assembly or turbine rotor may be equipped with three blades, and the vertical projection of the mentioned three blades may form a non-closed circle.

The distance between the chord midpoint of the mentioned airfoil cross-section to the mentioned vertical line may be the same as the length of the mentioned connecting arm. The mentioned vertical line may be superposed with the axis of the mentioned rotor shaft, and the length of the mentioned rotor shaft may be less than or equal to the vertical distance between the top most airfoil cross section to the bottom most airfoil sectional circle in the mentioned blade.

In an alternative embodiment, the length of the mentioned rotor shaft may be more than or equal to the vertical distance between the top most airfoil cross section to the bottom most airfoil sectional circle in the mentioned blade.

The distance between the chord midpoint of the mentioned airfoil cross-section to the mentioned vertical line may be the same as the length of the mentioned connecting arm airfoil. The mentioned vertical line may be superposed with the axis of the mentioned rotor shaft, and the length of the mentioned rotor shaft may be less than or equal to the vertical distance between the top most airfoil cross section to the bottom most airfoil sectional circle in the mentioned blade.

The mentioned line intersectant with the mentioned vertical line and midpoint of the mentioned chord in the same plane may form an angle of between about 30° to about 150° with the mentioned chord, wherein, the first line and the second line may form an angle of from about 50° to about 200°.

Preferably the mentioned line intersectant with the mentioned vertical line and midpoint of the mentioned chord in the same plane may form an angle of between about 70° to about 110° with the mentioned chord, wherein, the first line and the second line may form an angle of from about 80° to about 150°.

More preferably the mentioned line intersectant with the mentioned vertical line and midpoint of the mentioned chord in the same plane may form an angle of about 96°±5° with the mentioned chord, wherein, the first line and the second line may form an angle of about 120°.

Even more preferably the mentioned line intersectant with the mentioned vertical line and midpoint of the mentioned chord in the same plane may form an angle of about 96°±1° with the mentioned chord, wherein, the first line and the second line may form an angle of about 120°.

Preferably said vertical line is super-positioned with the axis of the rotor shaft.

The mentioned airfoil blade profile may comprise an airfoil measurement NACA XWYY, which is further defined in FIG. 13, where X is more than 0 and YY is between 6 and 24 inclusive. Preferably, the mentioned airfoil blade profile may comprise an airfoil measurement NACA X418, where X is between 1 and 6 Inclusive. Preferably, the mentioned airfoil blade profile may comprise an airfoil measurement NACA X418, where X is between 1 and 4 Inclusive. More preferably, the mentioned airfoil blade profile may comprise an airfoil measurement NACA X418, where X is between 1 and 3 Inclusive. Even more preferably, the mentioned airfoil blade profile may comprise an airfoil measurement NACA X418, where X is 2. Preferably, the mentioned airfoil blade profile may comprise an airfoil measurement NACA 2W18, where W is between 1 and 8 Inclusive. More preferably, the mentioned airfoil blade profile may comprise an airfoil measurement NACA 2W18, where W is between 2 and 8 Inclusive. Even more preferably, the mentioned airfoil blade profile may comprise an airfoil measurement NACA 2W18, where W is 4. Preferably, the mentioned airfoil blade profile may comprise an airfoil measurement NACA 24YY, where YY is between 6 and 30 Inclusive. More preferably, the mentioned airfoil blade profile may comprise an airfoil measurement NACA 24YY, where YY is between 10 and 20 Inclusive. Even more preferably, the mentioned airfoil blade profile may comprise an airfoil measurement NACA 24YY, where YY is between 16 and 19 inclusive. Most preferably, the mentioned airfoil blade profile may comprise an airfoil measurement NACA 24YY, where YY is 18.

The mentioned airfoil blade may comprise an anti-symmetric airfoil with a high Lift/Drag ratio. The mentioned airfoil blade may comprise an anti-symmetric airfoil with a high Lift/Drag ratio and a helical blade configuration. An embodiment of the present invention may have a large airfoil chord length to turbine radius ratio. An embodiment of the present invention may have an airfoil chord length of between about 5 cm and about 500 cm. Preferably, the mentioned airfoil chord length may comprise a chord length of between about 20 cm and about 300 cm. More preferably, the mentioned airfoil chord length may comprise a chord length of between about 22.5 cm and about 200 cm. Even more preferably the mentioned airfoil chord length may comprise a chord length of between about 22.5 cm and about 150 cm. Even more preferably, the mentioned airfoil chord length may comprise a chord length of between about 22.5 cm and about 100 cm. Even more preferably, the mentioned airfoil chord length may comprise a chord length of between about 22.5 cm and about 75 cm. Preferably the mentioned airfoil chord length may comprise a chord length of between about 75 cm and about 150 cm. More preferably, the mentioned airfoil chord length may comprise a chord length of between about 75 cm and about 100 cm. Even more preferably, the mentioned airfoil chord length may comprise a chord length of about 75 cm. The mentioned airfoil blade may have a height of between about 10 cm and about 5000 cm. Preferably, the mentioned airfoil blade may have a height of between about 100 cm and about 1000 cm. More preferably, the mentioned airfoil blade may have a height of between about 300 cm and about 800 cm. Even more preferably, the mentioned airfoil blade may have a height of between about 500 cm and about 700 cm. Even more preferably the mentioned airfoil blade may have a height of about 520 cm. An embodiment of the present invention may have an energy producing rotating assembly or turbine radius of between about 5 cm and about 3200 cm. Preferably, the present invention may have an energy producing rotating assembly or turbine radius of between about 30 cm and about 1000 cm. Preferably, the present invention may have an energy producing rotating assembly or turbine radius of between about 50 cm and about 800 cm. More preferably the present invention may have an energy producing rotating assembly or turbine radius of about 160 cm.

The energy producing rotating assembly or turbine rotor and blade of the airfoil blade cross section may have a high helical turbine solidity. Furthermore, the energy producing rotating assembly or turbine rotor and blade may have a high helical turbine solidity and an airfoil blade cross section characterized by NACA2418 or an asymmetrical airfoil with a lift/drag ratio. The high helical turbine solidity provides increased flow effects on the front side of the rotation such that they greatly outweigh the negative effects on the rear side of the rotation. Furthermore, the mentioned airfoil blade cross section of said high helical turbine solidity blade may have an optimal camber which minimizes the negative effects on the rear side of the rotation.

The mentioned energy producing rotating assembly or turbine rotor and blade may have a helical turbine solidity of >0.3, wherein the helical turbine solidity is calculated using the equation:

σ=NcD

σ—Solidity

N—Number of blades

c—Chord Length

D—Diameter

Preferably the mentioned energy producing rotating assembly or turbine rotor and blade may have a helical turbine solidity of between about 0.3 and about 1.2. More preferably the mentioned energy producing rotating assembly or turbine rotor and blade may have a solidity of between about 0.4 and about 0.9.Even more preferably the mentioned energy producing rotating assembly or turbine rotor and blade may have a solidity of >0.7. Most preferably the mentioned energy producing rotating assembly or turbine rotor and blade may have a solidity of about 0.7.

The airfoil blade may comprise a permanent, inherent angle of attack. The angle of attack is the angle relative to a line tangent and intersectant to the chord length midpoint and existing on the horizontal plane. Preferably the angle of attack may be between 0 degrees and about 180 degrees. More preferably the angle of attack may be between 0 degrees and about 100 degrees. Even more preferably the angle of attack may be between 0 degrees and about 30 degrees. Even more preferably the angle of attack may be between 0 degrees and about 10 degrees. Even more preferably of all the angle of attack may be about 6 degrees.

In a specific embodiment, the airfoil cross section has an airfoil chord length of between about 5 cm and about 500 cm and said blade(s) has a height of between about 10 cm and about 5000 cm and said energy producing rotating assembly has a radius of between about 5 cm and about 3200 cm and said energy producing rotating assembly has a helical turbine solidity greater than 0.3.

In a more specific embodiment, the airfoil cross section has an airfoil chord length of about 75 cm and said blade(s) has a height of about 520 cm and said energy producing rotating assembly has a radius of about 160 cm and said energy producing rotating assembly has a helical turbine solidity of 0.7.

In an even more specific embodiment, the airfoil cross section has an airfoil chord length of about 75 cm and said blade(s) has a height of about 520 cm and said energy producing rotating assembly has a radius of between about 50 cm and about 800 cm and said energy producing rotating assembly has a helical turbine solidity of about 0.7 and said blade(s) has an angle of attack of about 6 degrees.

The helical blade(s)may form an outer concave and/or convex surface with respect to the central rotor shaft. Preferably the mentioned blade(s) forms an outer concave surface with respect to the central rotor shaft.

The blade(s) may comprise, for example, fibreglass and/or carbon fibre and/or epoxide resin and/or high strength glass and/or plastic and/or foam and/or metal and/or wood and/or a mixture thereof.

In accordance with the above mentioned energy producing rotating assembly or turbine rotor, the energy producing rotating assembly or turbine rotor is connected to the turbine blade with above mentioned structure, along the vertical axis direction, the blade is twisted up from the bottom, and oblique torque will be produced at all aerodynamic or hydrodynamic drag on the blade when fluid comes from various directions, therefore, the energy producing rotating assembly or turbine rotor may self-start up and rotate with low fluid speed. The twisted structure of the blade provides an area of surface, at substantially every angle. The blade design is such that fluid, from substantially every direction, may be caught by the blade, forcing movement of the blade. Furthermore the blade design of the present invention provides a levelling of pulsating fluid, hence lowering vibration.

### BRIEF DESCRIPTION OF DRAWINGS

FIG. 1 is a schematic illustration of the energy producing rotating assembly or turbine rotor of the VAWT and the complete appliance provided by the present invention.

FIG. 2 is a schematic illustration of the vertical axis wind turbine of the present invention.

FIG. 3 is a schematic illustration, from a top down perspective, of a group of upper and a group of lower connecting arms and three blades.

FIG. 4 is a schematic illustration that indicates the vertical distance between upper sectional circle and lower sectional circle of wind blade and the airfoil of the wind blade provided by the present invention.

FIG. 5 is a schematic illustration of the wind blade and the present invention relating to the wind blade

FIG. 6 is a schematic illustration, from a side perspective, of the wind blade.

FIG. 7 is a schematic illustration, from a side perspective, of the wind blade.

FIG. 8 is a schematic illustration of a top view of a rotor blade located at various positions about a vertical rotation axis of a turbine; the vertical rotational axis is normal to the plane of the page.

FIG. 9 is a schematic illustration of a cross section of one embodiment of the turbine airfoil blade of the present invention.

FIG. 10 depicts power output parameters for three airfoil configurations.

FIG. 11 is a schematic illustration of the NACA2418 airfoil.

FIGS. 12A and B depicts predicted and actual power output data for the NACA2418 airfoil.

FIG. 13 depicts the NACA four digit series airfoils. FIG. 13A describes the equations relating to said NACA four digit series. FIG. 13B is a diagrammatic representation of values generated in said equations.

### DETAILED DESCRIPTION OF SPECIFIC EMBODIMENTS

Hereunder the present invention may be given further description on the mode of carrying out the invention with incorporation of the attached figures, wherein, the attached figures are only for reference and description assistance, which are not proportion or an accurate layout. Therefore, the actual mode of carrying-out the present invention may not be restricted by the proportion and layout relation indicated in the attached figures.

Provided herein is the airfoil cross section of turbine blade, where, the mentioned blade may be twisted up along a vertical line, vertical to a horizontal plane, and the distances between the mentioned vertical line and chord midpoint of leading edge and trailing edge of a series of airfoil cross sections of the mentioned blade may be the same. Moreover, the line intersectant with the mentioned vertical line and the mentioned chord midpoint in the same plane may form an angle of 96°±5° with the mentioned chord, wherein, the first line and the second line may form an angle of 120°. The mentioned first line may be the one intersectant with the mentioned vertical line and chord midpoint at the top most airfoil cross section of the mentioned blade, and the mentioned second line may be the one intersectant with the mentioned vertical line and chord midpoint at the bottom most airfoil cross section of the mentioned blade.

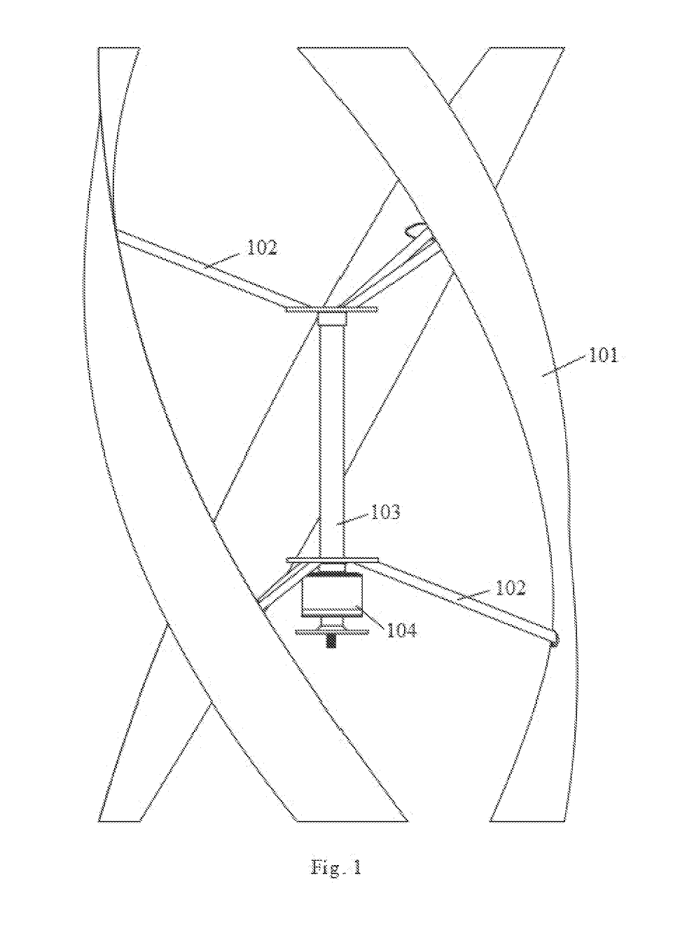

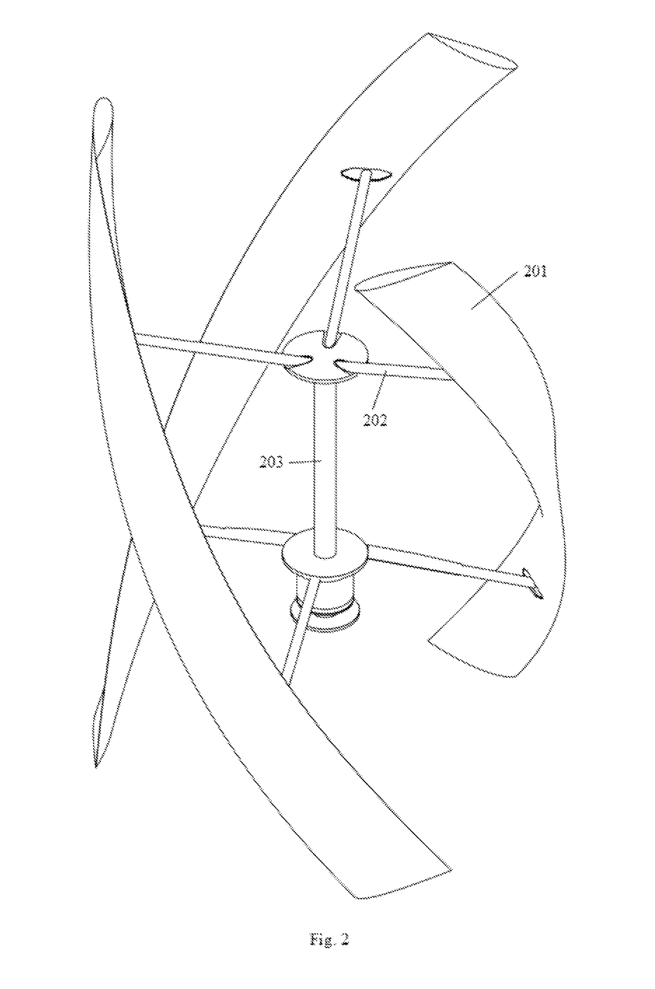

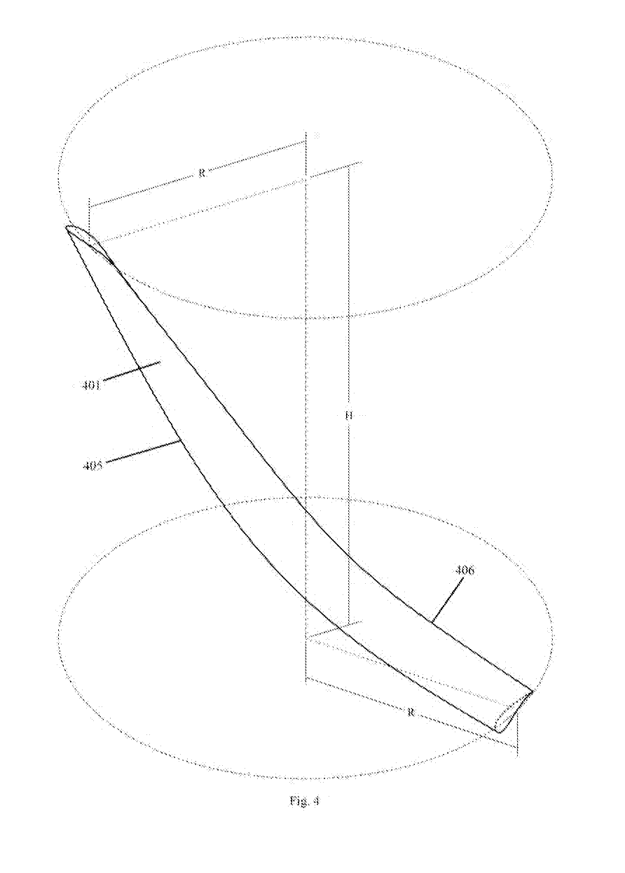

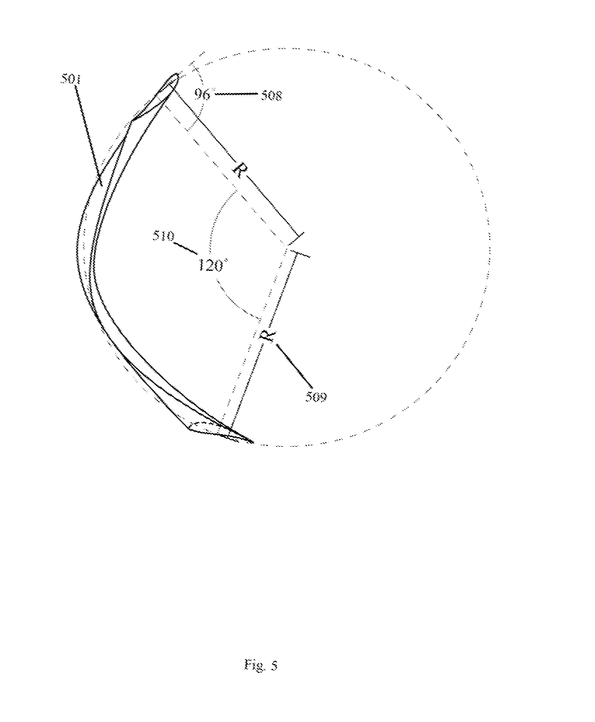

According to FIG. 1, FIG. 2, FIG. 4 and FIG. 5, applying the above-mentioned blade into the energy producing rotating assembly or turbine rotor of the vertical axis turbine, the rotor may comprise blade 101,201 connecting arm 102,202 and rotor shaft 103,203 and both ends of the connecting arm 102, 202 may be connected with the blade 101,201 and rotor shaft 103,203 respectively. Moreover, the complete appliance of the VAWT may include generator 104, wherein, with airfoil cross section, the blade 101 may be twisted up along a vertical line, vertical to horizontal plane. The distances between the mentioned vertical line and chord midpoint of the leading edge 405 and trailing edge 406 of a series of airfoil cross sections of the mentioned blade may be the same, and the line intersectant with the mentioned vertical line and the mentioned chord midpoint in the same plane may form an angle of 96°±5° 508 with the mentioned chord, wherein, the first line and the second line may form an angle of 120° 510. The mentioned first line may be the one intersectant with the mentioned vertical line and chord midpoint at top most airfoil cross section of the mentioned blade, and the mentioned second line may be the one intersectant with the mentioned vertical line and chord midpoint at bottom airfoil cross section of the mentioned blade.

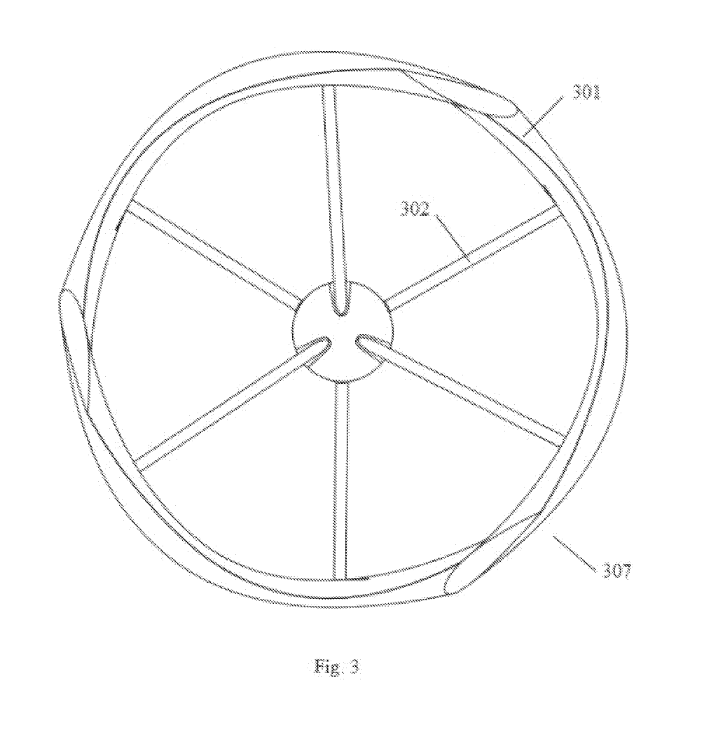

During the fabrication and erection process of the blade, the distance between the chord midpoint of the airfoil cross section and vertical line may be set to be equal to the length of connecting arm usually, and the vertical line may be set to be superposition with axis of wheel axle. Such setup can decrease the drag of blade, during operation, effectively. Preferably, three blades may be equipped for the energy producing rotating assembly or turbine rotor (as per FIG. 1, FIG. 2 and FIG. 3), and the vertical projection of the three blades may form a closed circle 307, so that fluid force from various directions may produce stronger oblique torque due to aerodynamic or hydrodynamic effect son the blade, and fluid power can be utilized more efficiently to enhance the energy producing rotating assembly or turbine rotor self-start and rotation with low fluid speed.

Based on for example NACA2418 airfoil or an asymmetric airfoil with high Lift/Drag ratio, the above-mentioned blade can be fabricated by methods as below.

With reference to FIG. 1, FIG. 2, FIG. 3, FIG. 4 and FIG. 5, a line segment L may be led from the chord midpoint of the leading edge and trailing edge of airfoil NACA2418, or an asymmetric airfoil with high Lift/Drag ratio which forms an angle of 96°±5° 508 with the mentioned chord. Preferably, the length R 509 of the line segment L may be set as the length of the connecting arm 102 of the energy producing rotating assembly or turbine rotor (the length is called radius of energy producing rotating assembly or turbine rotor usually under such condition). A vertical line may be made to connect the terminal point of the mentioned line segment L and be vertical to the plane, in which the terminal point of line segment L may be the one to connect with the chord midpoint of the leading edge 405 and the trailing edge 406 of the airfoil cross section. The distance between the vertical line and the chord midpoint of the leading edge and the trailing edge of the airfoil cross section may be R, and preferably the vertical line may be setup to be superposed with the axis of the rotor shaft 103. Taking the vertical line as axis, the airfoil blade 101 may be twisted up with constant speed around the vertical line. During twirling process, the angle of 96°±5° 508 formed by line segment L and chord between leading edge 405 and trailing edge 406, and the distance L between the chord midpoint and the vertical line may be kept unchanged. The blade 101,201,301 can be formed after 120° 510 horizontal rotation. The vertical twirling height i.e. the vertical distance between the top most cross section and the bottom sectional circle of the blade may be as per FIG. 1, FIG. 2 and FIG. 3, which may be longer than or equal to the length of rotor shaft.

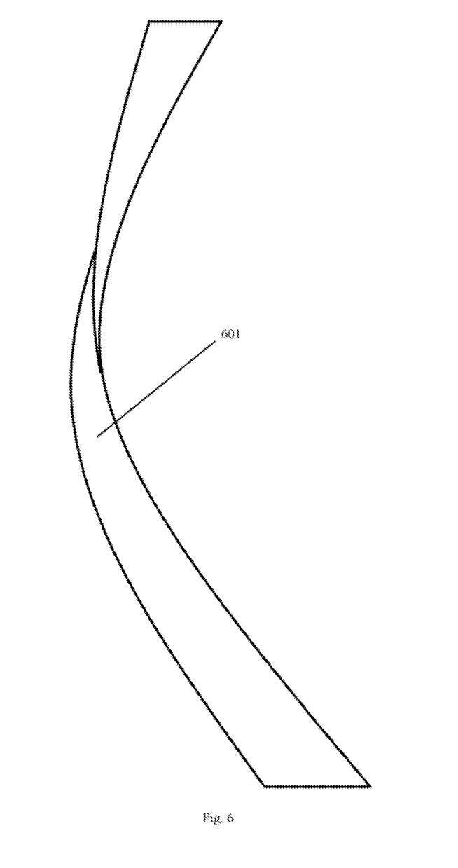

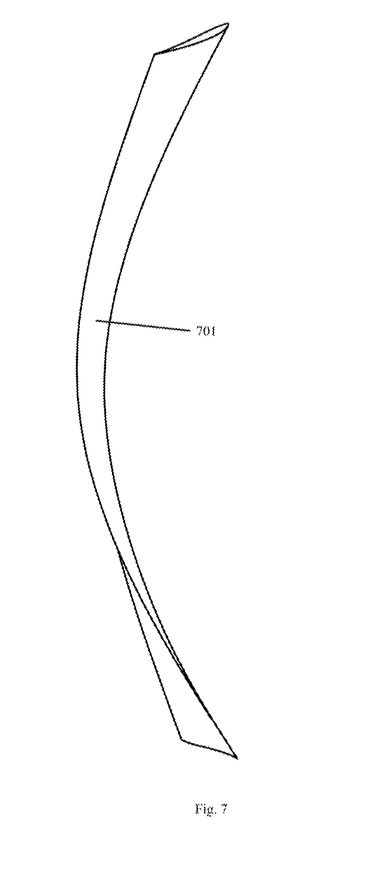

With reference to FIG. 4, FIG. 6 and FIG. 7, the blade 401,601,701 of the VAWT with above-mentioned structure made as per the above-mentioned method, and the energy producing rotating assembly or turbine rotor connected to the turbine blade with the adoption of above-mentioned structure, forms a twisted structure from bottom to top along the vertical axle direction. The aerodynamic or hydrodynamic effects on the blade may produce oblique torque when fluid comes from various directions, therefore, the energy producing rotating assembly or turbine rotor can be started up and twirled automatically with low wind speed.

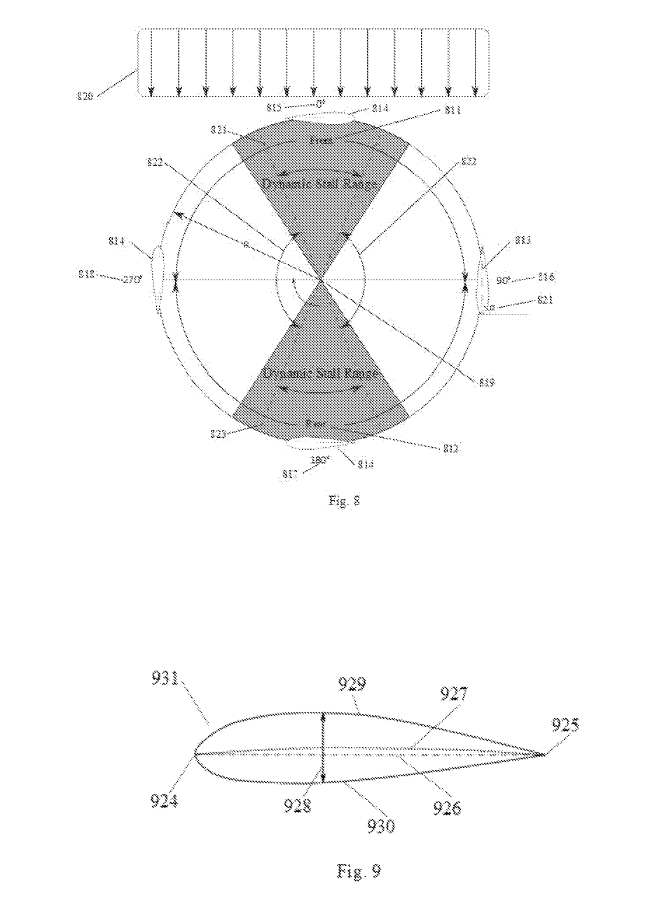

With reference to FIG. 8, turbine blades are susceptible to dynamic stall. The blade cross-sections 814 are located at various possible azimuthal angles (0°, 90°, 180°, 270°) 815, 816, 817 and 818 about a vertical rotational axis 819. Four blades are shown to illustrate four respective azimuthal angles. The traversed section at any one point in time would reveal any two blades on opposing respective sides of the vertical axis 819. As the blade cross section 814 rotates clockwise about the vertical axis 819, the blade cross section 814 experiences varying angles of attack relative to incident fluid 820. The angle of attack 821 is the angle between the oncoming fluid and the chord of the blade cross section 814. The oncoming fluid vector is the vector sum of the incident fluid velocity vector and the velocity of the rotating blade cross section 814. At low angles of attack, air flows smoothly over the surfaces of the blade cross section 814 and the cross section experiences lift, which is useful for urging continued rotation of a blade about the vertical axis 819. This lift increases with increasing angle of attack up to an angle at which flow separation begins at the blade cross section 814, the present invention provides prolonged lift phases 822. When the flow of fluid begins to separate from the blade cross-section, surface lift no longer increases, and lift may drop suddenly. Thus, there is a critical angle of attack at which the blade experiences critical lift. As the angle of attack 821 continues to increase, the flow of fluid in the blade's wake becomes increasingly turbulent. At attack angles beyond the critical angle, the lift and pitching movements experienced by the blade cross section 814 decrease sharply and are accompanied by a large increase in drag, as the blade cross section 814 stalls, the present invention provides reduced dynamic stall regions 823. The ability of a turbine to generate power is reduced whenever one or more rotor blades experience stall conditions, and rapid changes in the pitching moment can be destructive to the turbine. It is therefore desirable that the stall conditions be avoided, or at least minimized. Previously, the key reason for stall conditions was thought to be a large virtual camber 813 and incidence induced by the flow curvature effects, which slightly enhances the power extraction in the frontal half 811, but greatly increases the power loss in the rear half 812. Virtual camber is the effect on the aerodynamic and or hydrodynamic characteristics of an airfoil experiencing a constantly changing angle of attack relative to the incident fluid flow similar to the effect of camber on an airfoil in linear fluid flow. However, the present invention provides reduced dynamic stall regions 823 with a large virtual camber 813.

With reference to FIG. 9, one embodiment of the present invention is an asymmetrical airfoil 931 having a leading edge 924, a trailing edge 925 and a chord line 926, the present invention may have a non-linear mean camber line 927. The mean camber line may be positive and characterized as lying above the chord line 926, thus providing improved performance in the frontal and rear half of the airfoil. The thickness 928 is variable along the length of the airfoil and the present invention may be characterized by the NACA 4-series airfoil equations. The upper surface 929 is generally associated with higher flow velocity and lower static pressure. The upper surface of the present invention 929 may be characterized by a curved surface with overall arc length greater than the lower surface and may have one change of sign of slope along the path from leading edge to trailing edge. The lower surface 930 has a comparatively higher static pressure and lower flow velocity than the upper surface. The pressure gradient between these two surfaces contributes to the lift force generated for a given airfoil. The lower surface 930 of the present invention may be characterized by a curved surface with an overall arc length less than the upper surface. The present invention may be characterized by a slope change, which may occur once or more, on the lower surface 930.

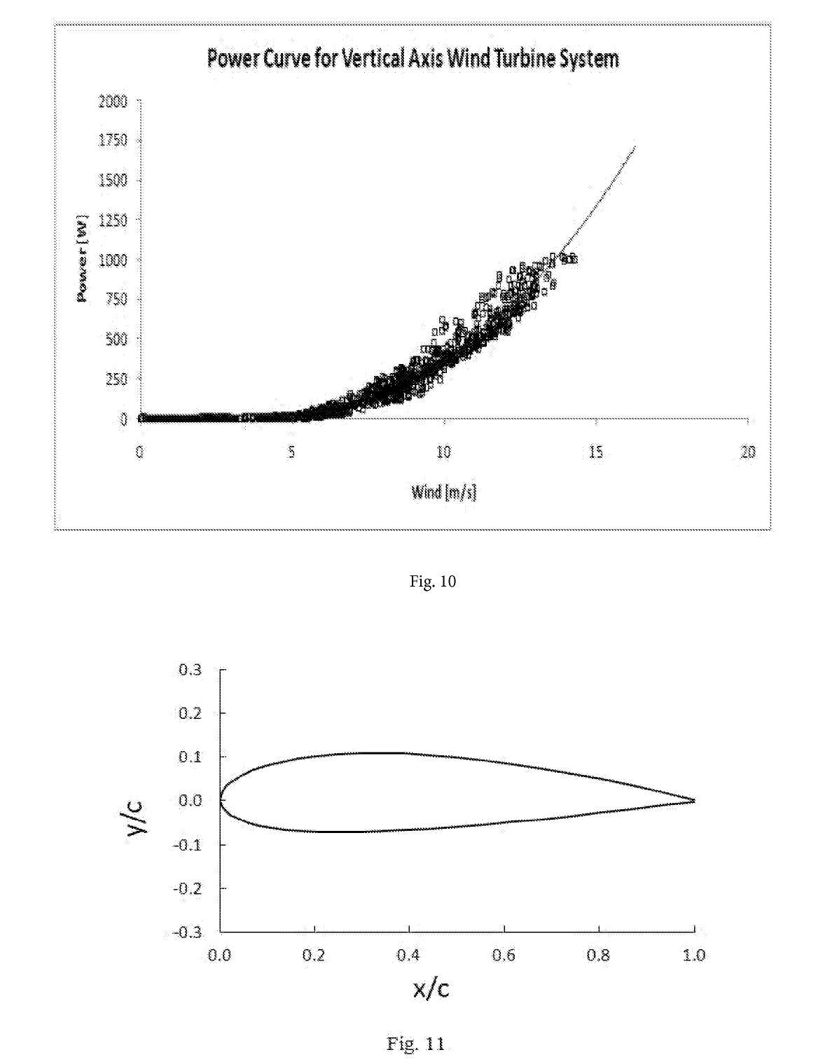

FIG. 10 depicts data related to the power output parameters for three airfoil configurations from a small-scale prototype VAWT. A preferred embodiment of the present invention airfoil NACA2418, showed improved power output parameters in comparison to other known airfoils.

A preferred embodiment of the invention, the NACA2418 airfoil is depicted in FIG. 11, where the variable ‘c’ represents chord length and the airfoil is shown in a dimensionless form by using y/c and x/c, to provide dimensionless coordinates which define an airfoil. Multiplying the dimensionless coordinates by the chord length ‘c’ will provide the dimensions for a full-scale airfoil.

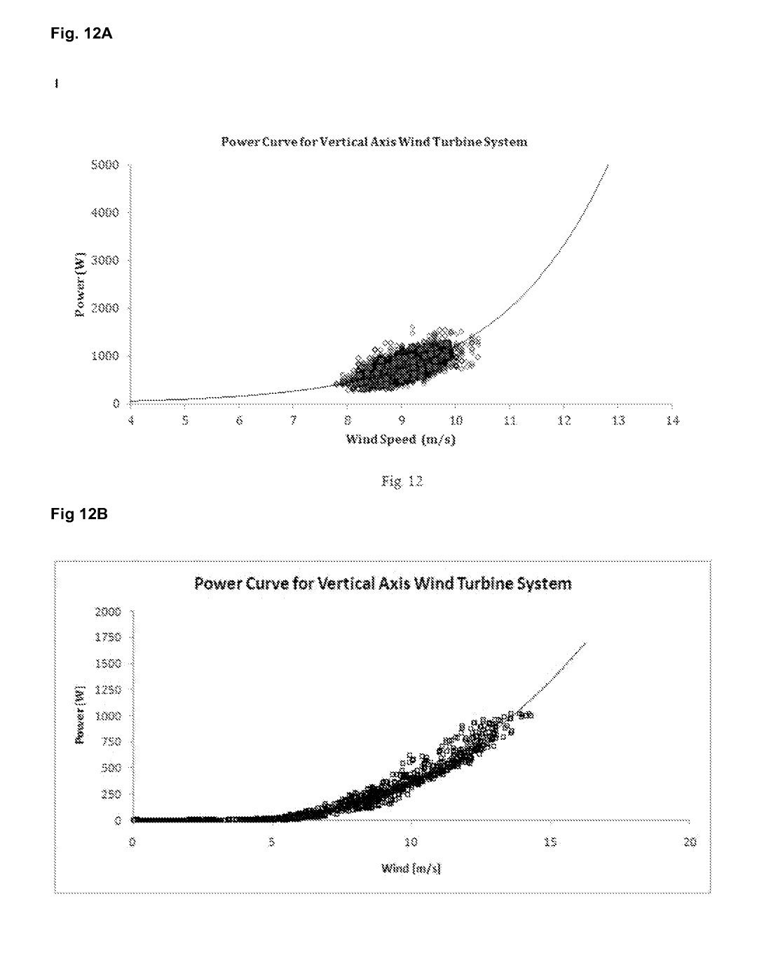

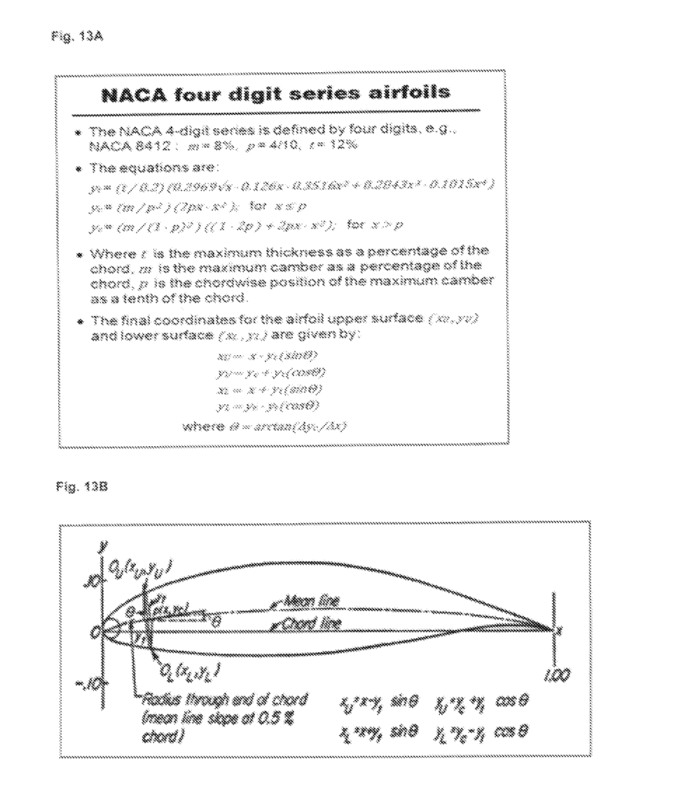

FIGS. 12A and B depict one embodiment of the invention where predicted (line) and actual data (points) related to power output parameters for the NACA2418 airfoil blade in conjunction with a vertical axis wind turbine are shown. The actual data showed significant improved efficiency and overall power output at a range of wind speeds from 8 m/s to 10 m/s.

The above-mentioned is only the preferred embodiment of the present invention, however, since this present invention may be structurally modified in various forms by those skilled in the art, while its utilities remained unchanged, the extent of protection of the present invention may be subject to the protection domain stipulated by Claims.

Various references are cited throughout this specification, each of which is incorporated herein by reference in its entirety.

1. An energy producing rotating assembly comprising blade(s) with an airfoil cross section, wherein said airfoil cross section has an asymmetrical airfoil measurement NACA XWYY, wherein X is more than 0 and W is more than 0 and YY is between 6 and 30 inclusive.

2. The energy producing rotating assembly according to claim 1, comprising blade(s) with an airfoil cross section, wherein said airfoil cross section has an asymmetrical airfoil measurement NACA XWYY, wherein X is more than 0 and W is more than 0 and YY is 18.

3. The energy producing rotating assembly according to claim 1, comprising blade(s) with an airfoil cross section, wherein said airfoil cross section has an asymmetrical airfoil measurement NACA XWYY, wherein X is 2 and W is 4 and YY is between 6 and 30.

4. The energy producing rotating assembly according to claim 1, comprising blade(s) with an airfoil cross section, wherein said airfoil cross section has an airfoil measurement of NACA 2418.

5. The energy producing rotating assembly as in according to claim 1, wherein said energy producing rotating assembly is a turbine.

6. The energy producing rotating assembly according to claim 1, wherein said energy producing rotating assembly is a vertical axis wind turbine.

7. The energy producing rotating assembly according to claim 1 wherein said airfoil cross section has an airfoil chord length of between about 5 cm and about 500 cm.

8. The energy producing rotating assembly according to claim 1, wherein said airfoil cross section has an airfoil chord length of about 75 cm.

9. The energy producing rotating assembly according to claim 1, wherein said blade(s) has a height of between about 10 cm and about 5000 cm.

10. The energy producing rotating assembly according to claim 1, wherein said blade(s) has a height of about 520 cm.

11. The energy producing rotating assembly according to claim 1, wherein said energy producing rotating assembly has a radius of between about 5 cm and about 3200 cm.

12. The energy producing rotating assembly according to claim 1, wherein said energy producing rotating assembly has a radius of about 160 cm.

13. The energy producing rotating assembly according to claim 1, wherein said energy producing rotating assembly has a helical turbine solidity greater than about 0.3.

14. The energy producing rotating assembly according to claim 1, wherein said energy producing rotating assembly has a helical turbine solidity between about 0.3 and about 1.2.

15. The energy producing rotating assembly according to claim 1, wherein said energy producing rotating assembly has a helical turbine solidity of about 0.7.

16. The energy producing rotating assembly according to claim 1, wherein said airfoil cross section has an airfoil chord length of between about 5 cm and about 500 cm and said blade(s) has a height of between about 10 cm and about 5000 cm and said energy producing rotating assembly has a radius of between about 5 cm and about 3200 cm and said energy producing rotating assembly has a helical turbine solidity greater than 0.3.

17. The energy producing rotating assembly according to claim 1, wherein said airfoil cross section has an airfoil chord length of about 75 cm and said blade(s) has a height of about 520 cm and said energy producing rotating assembly has a radius of about 160 cm and said energy producing rotating assembly has a helical turbine solidity of 0.7.

18. The energy producing rotating assembly according to claim 1, wherein said airfoil cross section has an airfoil chord length of about 75 cm and said blade(s) has a height of about 520 cm and said energy producing rotating assembly has a radius of between about 50 cm and about 800 cm and said energy producing rotating assembly has a helical turbine solidity of about 0.7 and said blade(s) has an angle of attack of about 6 degrees.

19. The energy producing rotating assembly according to claim 1, wherein said energy producing rotating assembly has three blades and a vertical projection of said three blades form a closed circle.
